(19) United States
(12) Patent Application Publication
(10) Pub. No.: US 2007/0141275 A1
(43) Pub. Date: Jun. 21, 2007

(54) Liquid crystal composite

(75) Inventor: Rifat A.M Hikmet, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS, N.V., EINDHOVEN (NL)

(21) Appl. No.: 10/598,196

(22) PCT Filed: Feb. 17, 2005
(86) PCT No.: PCT/IB05/50601

§ 371 Date: Aug. 21, 2006

(30) Foreign Application Priority Data
Feb. 27, 2004 (GB) 0404372.5

(51) Int. Cl. C09K 19/52

(52) U.S. Cl. 428/1.1; 252/299.01; 428/1.3

(57) ABSTRACT

A liquid crystal composite comprises anisometric particles suspended in a liquid crystalline compound. The composite is characterised in that the particles are aligned in relation to the molecules of the liquid crystalline compound, and the orientation of the particles may be reversibly changed by the application of an electric field.

This invention relates to liquid crystal composites comprising anisometric particles having disc-like, flake-like, rod-like or ellipsoidal shapes. More particularly, but not exclusively, this invention relates to such liquid crystal composites for use in light valves, switchable mirrors, and other display and lighting applications.

Light valves and other suspended particle devices have been used for over fifty years for modulation of light and may be used for many purposes including, for example, alphanumeric displays, television displays, windows, mirrors, eyeglasses and the like to control the amount of light passing there through. A conventional prior art light valve may be described as a cell formed of two walls that are spaced apart by a small distance, at least one wall being transparent, the walls having electrodes thereon usually in the form of transparent conductive coatings. The cell contains a “light valve suspension”, namely small particles (usually needle-like organic particles) suspended in a liquid suspending medium.

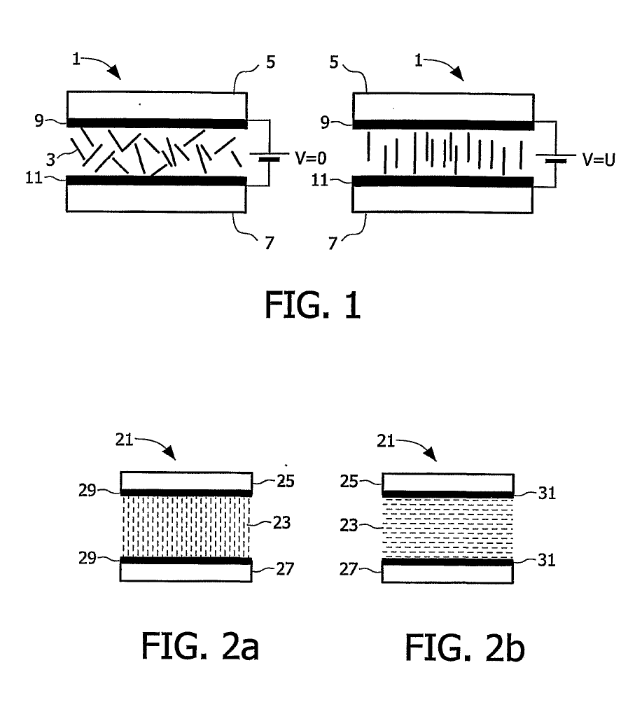

The working principle of such a device is illustrated in FIG. 1. The suspended particle device 1 comprises a layer of needle-like organic particles 3 sandwiched between a pair of glass substrates 5, 7. Each of the glass substrates 5, 7 is coated with a transparent electrode 9, 11 on its inner surface.

In the absence of an applied electrical field (V=0), the particles in the liquid suspension exhibit random Brownian movement, and hence a beam of light passing into the cell is reflected, transmitted or absorbed, depending upon the nature and concentration of the particles and the energy content of the light. When an electric field is applied through the light valve suspension in the light valve (V=U), the particles become aligned and for many suspensions most of the light can pass through the cell.

When reflective particles such as flakes are used, such a cell can be switched between reflecting and transparent states. In the reflecting state the flakes are aligned so their planar surface is parallel to the surface of the glass substrate, and in the transparent state the flakes are aligned so their planar surface is perpendicular to the surface of the glass substrate. It is easy to align the flakes in one direction at high speed by the application of an electric field. However, in the absence of an electric field the flakes slowly resume a random orientation as a result of Brownian motion.

Liquid crystal display (LCD) devices are also well known, and are common in many items of electronic equipment such as visual display units (VDUs) for computers, and televisions. Liquid crystalline compounds (i.e. compounds which have a liquid crystal phase and other compounds which do not have a liquid crystal phase but have properties that mean that they may be used as a component of liquid crystal compositions) are also well known. For example, in liquid crystal displays, multi component eutectic liquid crystal mixtures are used in order to obtain desired thermal and electrical properties.

A liquid crystal display comprises a liquid crystal cell having patterned electrodes. Alphanumeric displays are segmented and addressed directly, whereas multiplexing is also used in displays having horizontal and vertical electrodes. In the case of active matrix displays, the display also includes an array of diodes or transistors for switching individual pixels. Different liquid crystal (LC) cells have been developed in the recent years; the most important liquid display cells are the TN cell (twisted nematic cell), the STN cell (super twisted nematic cell), PDLC cells (polymer dispersed liquid crystal cells), etc. Liquid crystal cells normally use nematic liquid crystals, however, also smectic liquid crystals or cholesteric liquid crystals may be utilised.

All of the above-mentioned liquid crystal materials generally have common characteristics. They have a rod-like molecular structure, a rigidness of the long axis and dipoles and/or easily polarisable substituents, therefore providing permanent or induced dipoles.

The distinguishing characteristic of the liquid crystalline state is the tendency of the molecules to align in the same direction, called the director.

Macroscopic orientations in liquid crystals can be induced at treated interfaces. For example, on uniaxially rubbed surfaces the liquid crystals align in a uniaxial planar orientation, whereas on certain polymer or surfactant treated surfaces the liquid crystals align perpendicular to the surfaces. It is also possible to induce a tilted orientation using a suitable orientation inducing layer. FIG. 2 shows liquid crystal cells 21 comprising a liquid crystalline compound 23 sandwiched between surfaces 25, 27. In FIG. 2a the surfaces 25, 27 have been treated with a surfactant to form layers 29, which force the liquid crystals to oriented perpendicular to the treated surfaces. In FIG. 2b the surfaces 25, 27 have been uniaxially rubbed, so the liquid crystalline composition is adjacent to rubbed polymer 31. Consequently, the liquid crystals assume a uniaxial parallel orientation with respect to the treated surfaces.

The orientation of molecules in a liquid crystal cells can also be controlled by applying an electric or magnetic field to the cell. Liquid crystal mixtures tend to exhibit dielectric anisotropy. Liquid crystal mixtures exhibit positive dielectric anisotropy when a dielectric constant is larger in the direction of the director than in the lateral directions. Liquid crystal mixtures exhibit negative dielectric anisotropy when a dielectric constant is smaller in the direction of the director than in the lateral directions. Liquid crystal mixtures having positive dielectric anisotropy tend to orient their long axis (director) along the direction of an applied field, whereas liquid crystal mixtures having negative dielectric anisotropy tend to orient their long axis (director) perpendicular to an applied field.

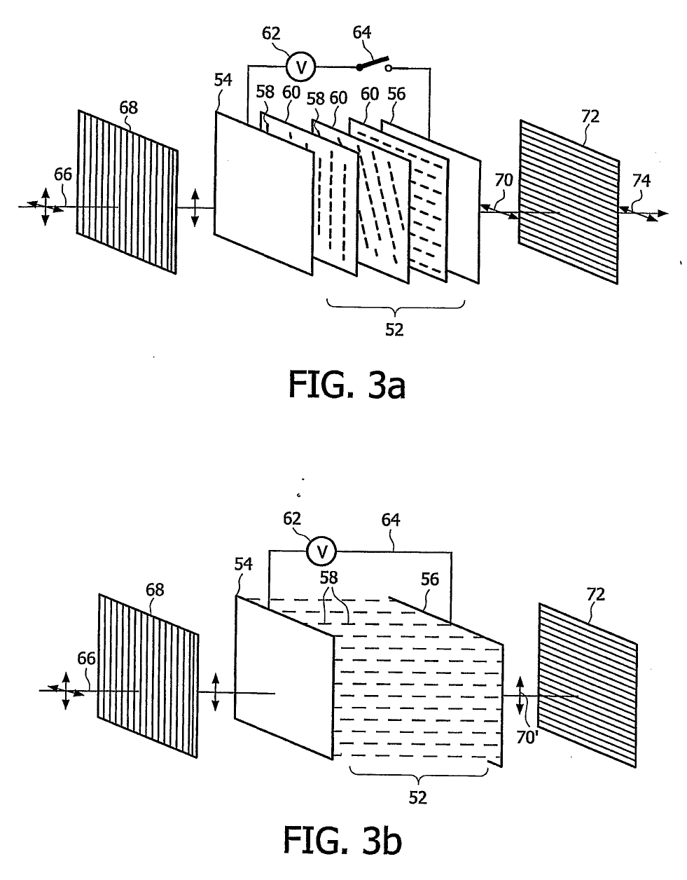

By applying an electric or magnetic field to a cell containing liquid crystal molecules, the director can be switched gradually between two states or orientations, namely an “on-state”, where the liquid crystal cell is transparent in a predetermined direction, and an “off-state”, where the liquid crystal cell is not transparent in the predetermined direction. FIGS. 3a and 3b illustrate the operation of a conventional twisted nematic LC cell in the transmissive mode. The LC cell 52 consists of a pair of parallel transparent plates 54 and 56, such as glass, which serve as electrodes when coated with a film of a transparent conductive material such as ITO (indium tin oxide). A 200 nm thick polymer film is coated on the ITO to serve as an alignment layer for the adjacent LC molecules. A nematic LC between the two plates rotates helically about an axis normal to the plates (the axis of twist). If the twist angle is 90°, for example, the LC molecules have their directors 58 in the x direction at one of the plates and in the y direction at the other plate. For example, in FIG. 3a the LC directors are shown aligned in the y direction adjacent plate 54 and in the x direction adjacent plate 56; in both cases they are parallel to the planes of the plates.

FIGS. 3a and 3b illustrate the unitary cell 52 in an exploded form with successive LC layers 60 that actually form a continuum shown separately. The LC directors for each successive layer are angularly twisted relative to the preceding layer, resulting in an overall “twist” from one plate to the other. A modulating voltage source 62 is connected across the electrodes of the opposed plates through a switch 64. An unpolarized input beam 66 which contains an image or other optical data is directed through a polarizing plate 68 so that it is polarized parallel to the LC directors upon entering the cell at the input plate 54. The polarization plane of the linearly polarized light travelling in the direction of the LC twist axis rotates along with the LC molecules, so that the cell acts as a polarization rotator. This is known as the polarization rotation effect (PRE). At the output of the cell the light polarization has been rotated 90° (assuming a 90° LC twist angle), so that its polarization 70 is in the x direction at the output of the cell. An analyzer implemented with another polarizing plate 72 whose polarization plane is twisted 90° from that of polarizing plate 68, transmits the polarized beam as an output 74.

When the switch 64 is closed and a modulating voltage is applied across the cell's electrode plates 54 and 56, an electric field is established within the cell in the direction of the twist axis. This causes the LC molecules to tilt towards the field. When the applied modulating voltage is great enough to produce a 90° LC tilt, the LC molecules loose their twisted character (except for those adjacent to the boundary plate surfaces), so that the polarization rotational power is deactivated. This is illustrated in FIG. 3b, in which the LC directors 58 have been tilted 90° so that they are parallel to the beam 66 and at right angles to the boundary plates 54 and 56. As a result, the polarization 70′ of the cell's output beam is the same as the beam's polarization at the input end of the cell, and the output beam is blocked by the cross-polarized analyser 72. In effect, the analyser acts as a shutter which transmits light in the absence of an electric field and blocks the light transmission when the field is applied. Lower modulating voltages that only partially tilt the LC molecules result in a partial transmittance and partial blocking of input light.

The transmissive display illustrated in FIGS. 3a and 3b can be converted to a reflective system by substituting a mirror for the plate 72.

The liquid crystal cells described above have a complicated structure and provide limited light switching functionality. Similarly, conventional light valves also provide limited light switching functionality.

According to an aspect of the invention, there is provided a liquid crystal composite comprising anisometric particles suspended in a liquid crystalline compound characterised in that the particles are aligned in relation to the molecules of the liquid crystalline compound, and the orientation of the particles may be reversibly changed by the application of an electric field.

Application of an electric field across the composite induces a rapid change in the orientation of the particles, and subsequent removal of the electric field causes the particles to switch back to their original alignment. Thus, the present invention allows rapid and reversible switching of the particles between two different orientations.

The anisometric particles may comprise a single layer or several layers of material, which may be metallic, organic or inorganic.

The shape of the particles used in the composite is “anisometric”, i.e. the shape or structure of the particle is such that in one orientation the particle intercepts more light than in another orientation. Anisometric particles which are needle-shaped, rod-shaped, lath-shaped, disc shaped, ellipsoidal shaped, or in the form of thin flakes, are suitable. Thin flakes composed of a material having surfaces that are highly reflective in the visible range are especially useful for switchable mirror applications, but any type of light-absorbing or light-reflecting material can be employed depending on the desired result. Aluminium and silver are examples of suitable highly reflecting materials. The particles may also be of multi layer dielectric materials, also known as Bragg reflectors, which reflect light in the visible range with almost no absorption losses.

The ratio between the thickness and length of the anisometric particles is preferably at least 1:4, and more preferably at least 1:100. The smallest dimension, such as the thickness, of the anisometric particles is preferably in the range 5 nm to 1 μm, and more preferably in the range 5 nm to 100 nm, and the largest dimension, such as the length, of the anisometric particles is preferably in the range 20 nm to 50 μm, and more preferably in the range 100 nm to 10 μm.

The composite preferably comprises 10% by weight or less of the anisometric particles.

Surface treatment of the anisometric particles results in the macroscopic alignment of these particles with respect to the liquid crystal molecules in which they are suspended. If the surfaces of the particles are not treated in a suitable manner, then they become randomly oriented. Suitable surface treatments include treatments with surfactant, and techniques such as uniaxial rubbing and photo-alignment. These and other surface treatments will be well known to those skilled in the art.

For example, in the case of silver or gold particles, a suitable surfactant comprises a compound containing one or more thiol groups. Particles made of certain materials, e.g. aluminium or silicon, will exhibit an oxide layer on their surface. A suitable surfactant for treating particles that exhibit an oxide layer comprises a compound containing one or more silane carboxylate groups. Molecules with acid groups such as sulphonic or phosphonic acid may also be used.

The composite is preferably disposed between two substrates, each of which is surface-treated to induce macroscopic orientation of the molecules of the liquid crystalline compound. Suitable surface treatments include treatments with surfactant, and techniques such as uniaxial rubbing and photo-alignment. As above, suitable surface treatments will be well known to those skilled in the art.

The substrates are preferably coated with electrically conductive electrodes. At least one of the substrates and its respective electrode are preferably at least partially transparent to light. For example, the substrates may be made of glass and coated with indium tin oxide (ITO).

According to another aspect of the invention, there is provided a liquid crystal cell comprising: first and second substrates spaced apart, at least one substrate being transparent; first and second electrodes formed on the respective first and second substrates, at least one electrode being transparent; first and second alignment layers formed on the respective first and second electrodes; and the liquid crystal composite according to any one of the preceding claims disposed between the two substrates.

The first and second substrates are preferably spaced apart by a small distance, for example less than 5 mm. The alignment layers are preferably at least one of a surfactant treated surface, a polymer treated surface and a uniaxially rubbed surface. According to yet another aspect of the invention, there is provided a method of reversibly changing the orientation of anisometric particles in a liquid crystal composite, the method comprising the steps of: suspending the particles in a liquid crystalline compound wherein the particles are aligned in relation to the molecules of the liquid crystalline compound; and applying an electric field across the composite. The invention also provides a display device, a switchable mirror, and a means for changing the direction or shape of a beam of light from a light source, each comprising the liquid crystal cell according to claim 14.

For a better understanding of the above features and advantages of the invention, embodiments will now be described, purely by way of example, with reference to the accompanying drawings in which:

FIG. 1 shows the structure of a prior art suspended particle device, or light valve, in section;

FIG. 2a shows a prior art liquid crystal cell, in section, wherein the surfaces of the cell have been treated with surfactant;

FIG. 2b shows a prior art liquid crystal cell, in section, wherein the surfaces of the cell have been uniaxially rubbed;

FIGS. 3a and 3b are simplified exploded perspective views illustrating the operation of a conventional twisted nematic LC cell;

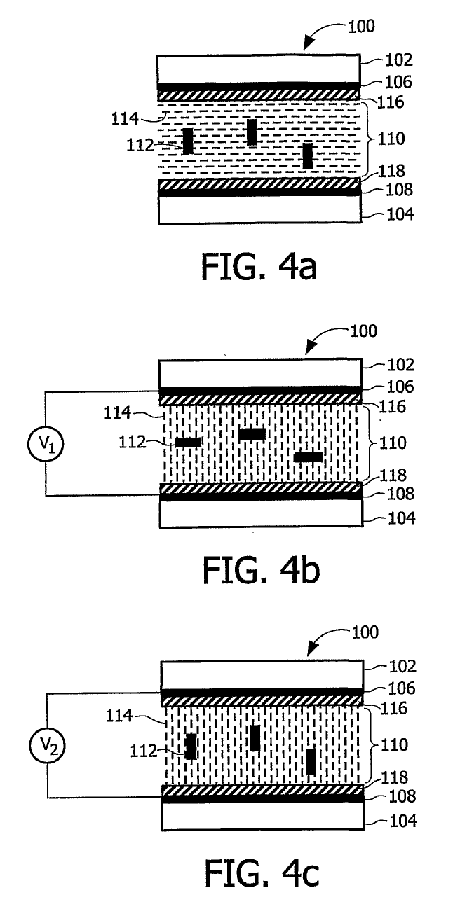

FIGS. 4a, 4b and 4c show a liquid crystal cell, in section, according to the invention;

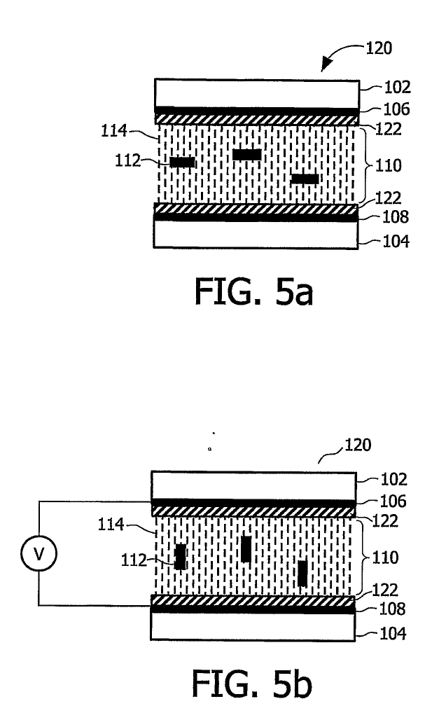

FIGS. 5a and 5b show another liquid crystal cell, in section, according to the invention;

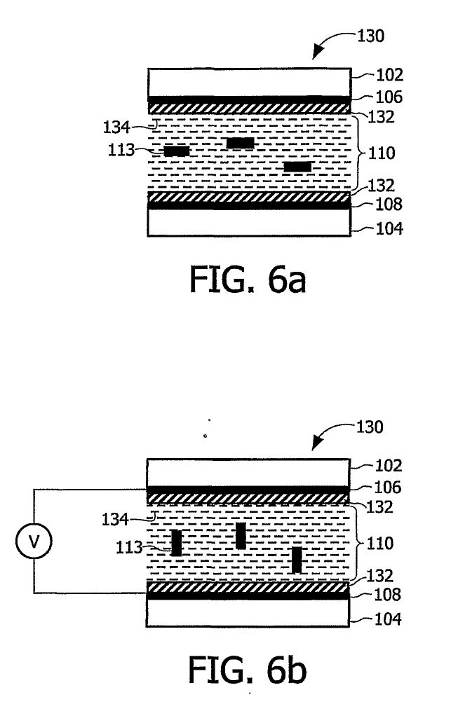

FIGS. 6a and 6b show another liquid crystal cell, in section, according to the invention;

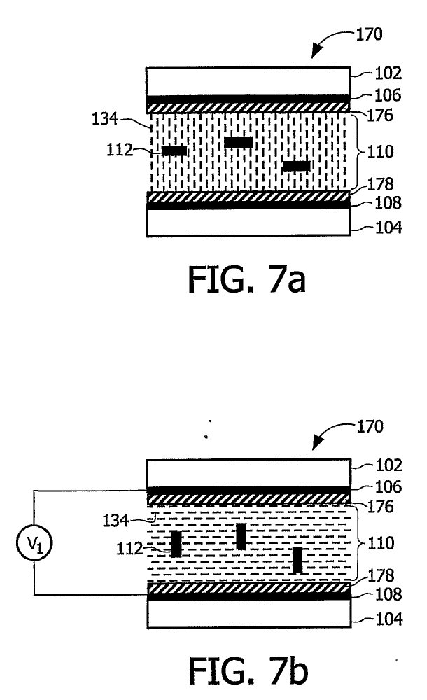

FIGS. 7a, and 7b show another liquid crystal cell, in section, according to the invention;

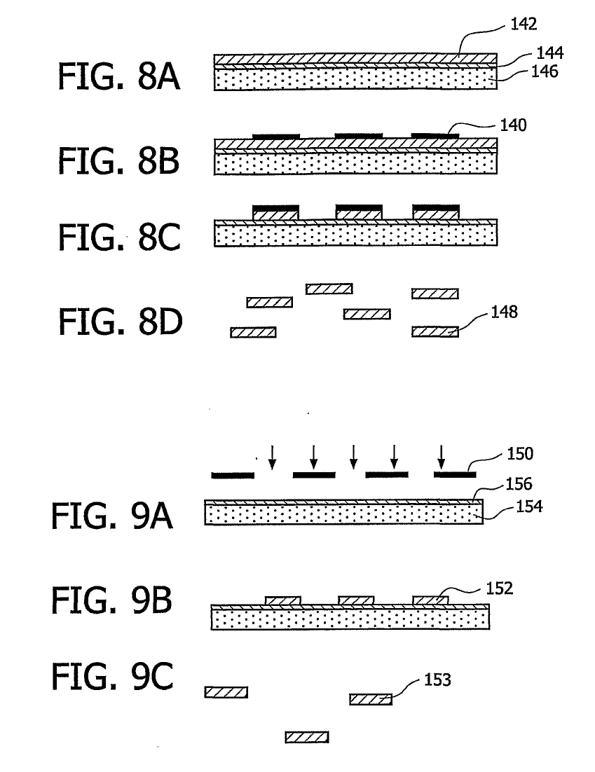

FIG. 8 schematically shows a first method of producing anisometric particles for use in embodiments of the present invention;

FIG. 9 schematically shows a second method of producing anisometric particles for use in embodiments of the present invention;

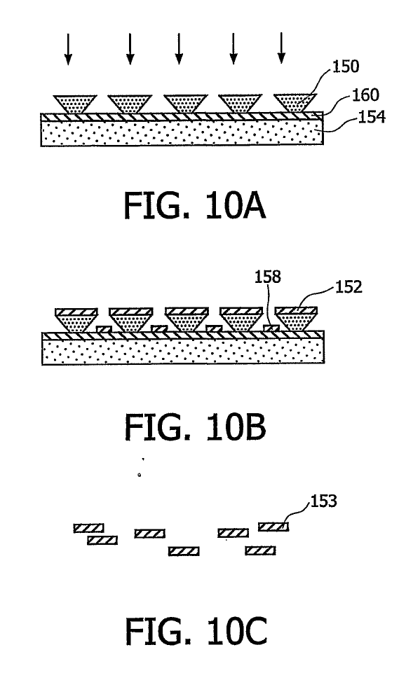

FIG. 10 schematically shows a third method of producing anisometric particles for use in embodiments of the present invention;

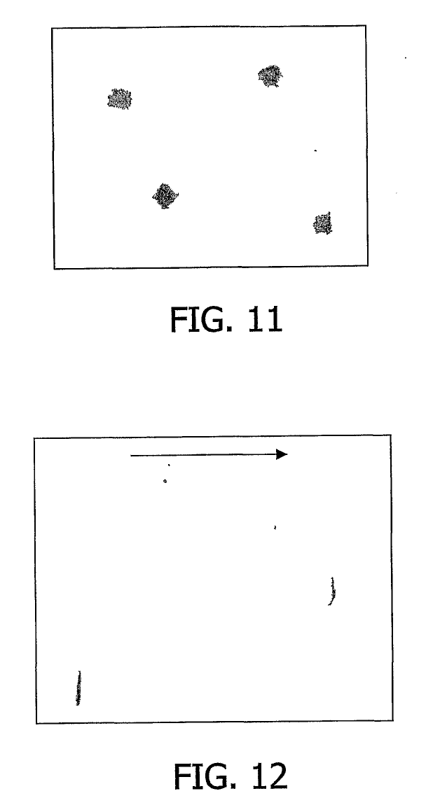

FIG. 11 shows a representation of flakes in a liquid crystal cell according to the invention, viewed from the top surface of the cell. The particles are oriented parallel to the cell surface;

FIG. 12 shows a representation of particles in a liquid crystal cell according to the invention, viewed from the top surface of the cell. The particles are oriented perpendicular to the cell surface;

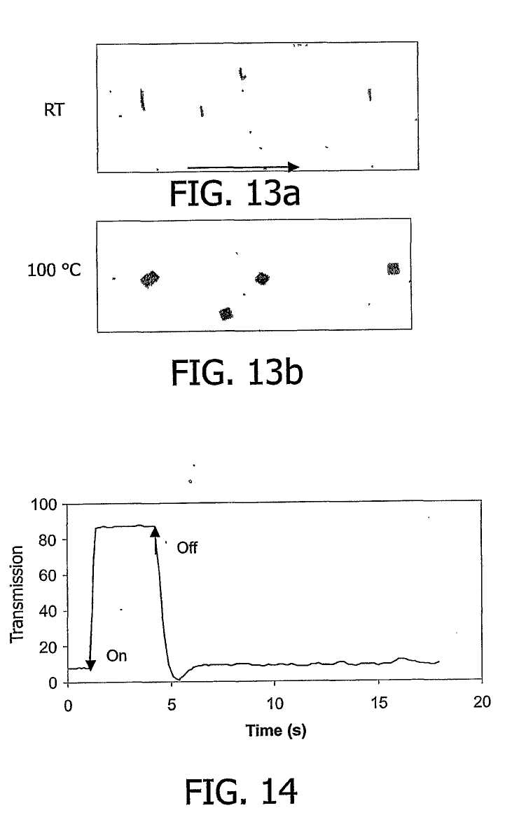

FIGS. 13a and 13b show liquid crystal-induced orientation of the particles in a liquid crystal cell according to the invention during the heating of the particles above the clearing temperature of the liquid crystal material;

FIG. 14 shows the effect of application of a voltage across a liquid crystal cell according to the invention on light transmission through the cell; and

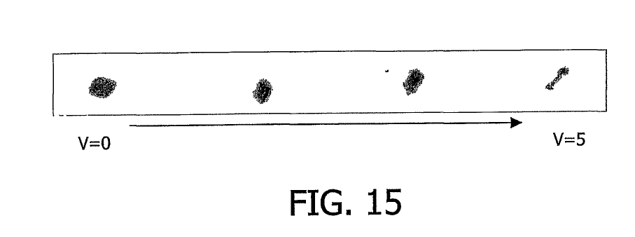

FIG. 15 is a representation of the continuously changing orientation of an anisometric particle in a liquid crystal cell according to the invention, which occurred when a voltage was applied across the cell.

FIGS. 4a to 4c schematically show a liquid crystal cell 100 according to the present invention. The liquid crystal cell 100 comprises two substrates 102, 104 that are spaced apart by a small distance, at least one substrate being transparent. Each substrate is associated with an electrode 106, 108, at least one electrode being transparent. For example, substrates 102, 104 may be glass, and electrodes 106, 108 may be ITO. A liquid crystal composite 110 comprising anisometric particles 112 suspended in a liquid crystalline compound with positive dielectric anisotropy 114 is disposed between the two substrates. The anisometric particles 112 are uniformly distributed throughout the liquid crystalline compound 114. The surfaces adjacent to the composite 110, i.e. the electrodes 106, 108, are treated in order to align the liquid crystal molecules. On uniaxially rubbed surfaces 116, 118 the liquid crystals 114 assume a uniaxial planar orientation with respect to the surfaces 102, 104, as shown in FIG. 4a. The anisometric particles 112 have also been surface treated so that they are aligned in relation to the molecules of the liquid crystalline compound 114. In FIG. 4a the particles 112 are aligned with their long axes perpendicular to the long axes of the liquid crystal molecules 114 due to surface treatment with a surfactant. Thus, in the resting state (V=0) shown in FIG. 4a, the anisometric particles 112 assume a defined orientation with respect to the liquid crystal molecules 114.

Application of an electric field, of strength V₁, as shown in FIG. 4b, causes the liquid crystal molecules with positive dielectric anisotropy 114 to realign in a direction parallel to the applied field. The anisometric particles 112, whose orientation is linked to the liquid crystal molecules 114, also realign to remain perpendicular to the liquid crystal molecules 114.

Application of an electric field, of strength V₂, wherein V₂>V₁, as shown in FIG. 4c, has no effect on the orientation of the liquid crystal molecules 114. However, the stronger electric field now causes the anisometric particles 112 to realign in a direction parallel to the applied field. Thus, in FIG. 4c, both the liquid crystal molecules 114 and the anisometric particles 112 are aligned with their long axes perpendicular to surfaces 102, 104.

When the electric field is turned off, both the liquid crystal molecules 114 and the anisometric particles 112 resume the orientations shown in FIG. 4a. Thus, the present invention provides the alignment of anisometric particles in two defined orientations, and rapid reversible switching between these orientations.

It will be apparent to those skilled in the art that it is possible for either the electrodes 106, 108 or the substrates 102, 104 to be located adjacent to the composite 110. However, it is the surface that is located adjacent to the composite that should be treated in order to align the liquid crystal molecules.

FIGS. 5a and 5b schematically show another liquid crystal cell 120 according to the present invention. The liquid crystal cell 120 comprises two substrates 102, 104 that are spaced apart by a small distance, at least one substrate being transparent. Each substrate is associated with an electrode 106, 108, at least one electrode being transparent. A liquid crystal composite 110 comprising anisometric particles 112 suspended in a liquid crystalline compound with positive dielectric anisotropy 114 is disposed between the two substrates. The anisometric particles 112 are uniformly distributed throughout the liquid crystalline compound 114. The surfaces of the electrodes 106, 108 adjacent to the composite 110 are treated with surfactant 122, and so, in a rest state (V=0), the liquid crystals 114 assume an orientation with their long axes perpendicular to the treated surfaces, as shown in FIG. 5a. The anisometric particles 112 are also surface treated with surfactant so that are aligned with their long axes perpendicular to the long axes of the liquid crystal molecules 114.

Application of an electric field, of strength V, as shown in FIG. 5b, does not cause realignment of the liquid crystal molecules 114 because they have positive dielectric anisotropy, and are already aligned in a direction parallel to the applied field. However, if the force exerted by the electric field is great enough, and is able to overcome the force that is orienting the anisometric particles 112 perpendicular to the liquid crystal molecules 114, then the anisometric particles 112 will realign in a direction parallel to the applied field. Thus, in FIG. 5b, both the liquid crystal molecules 114 and the anisometric particles 112 are aligned with their long axes perpendicular to surfaces 102,104.

When the electric field is turned off (V=0), the orientation of the anisometric particles 112 will again be directed by the liquid crystal molecules 114, as shown in FIG. 5a.

FIGS. 6a and 6b schematically show another liquid crystal cell 130 according to the present invention. The liquid crystal cell 130 comprises two substrates 102, 104 that are spaced apart by a small distance, at least one substrate being transparent. Each substrate is associated with an electrode 106, 108, at least one electrode being transparent. A liquid crystal composite 110 comprising anisometric particles 113 suspended in a liquid crystalline compound with negative dielectric anisotropy 134 is disposed between the two substrates. The anisometric particles 113 are uniformly distributed throughout the liquid crystalline compound 134. The surfaces of the electrodes 106, 108 adjacent to the composite 110 are treated by uniaxial rubbing 132, and so the liquid crystals 114 assume an orientation with their long axes parallel to the treated surfaces, as shown in FIG. 6a. The anisometric particles 113 have also been surface treated by uniaxial rubbing and are aligned with their long axes parallel to the long axes of the liquid crystal molecules 134.

Application of an electric field, of strength V, as shown in FIG. 6b, does not cause realignment of the liquid crystal molecules 134 because they have negative dielectric anisotropy, and are already aligned in a direction perpendicular to the applied field. However, if the force exerted by the electric field is great enough, and is able to overcome the force that is orienting the anisometric particles 113 parallel to the liquid crystal molecules 134, then the anisometric particles 113 will realign in a direction parallel to the applied field.

When the electric field is turned off, the orientation of the anisometric particles 113 will again be directed by the liquid crystal molecules 134, as shown in FIG. 6a.

FIGS. 7a and 7b schematically show another liquid crystal cell 170 according to the present invention. The liquid crystal cell 170 comprises two substrates 102, 104 that are spaced apart by a small distance, at least one substrate being transparent. Each substrate is associated with an electrode 106, 108, at least one electrode being transparent. For example, substrates 102, 104 may be glass, and electrodes 106, 108 may be ITO. A liquid crystal composite 110 comprising anisometric particles 112 suspended in a liquid crystalline compound with negative dielectric anisotropy 134 is disposed between the two substrates. The anisometric particles 112 are uniformly distributed throughout the liquid crystalline compound 134. The surfaces of the electrodes 106, 108 adjacent to the composite 110 are treated with surfactant 176, 178 in order to align the liquid crystal molecules. At surfaces 176, 178 the liquid crystals 134 assume a uniaxial perpendicular orientation with respect to the substrates 102, 104, as shown in FIG. 7a. The anisometric particles 112 are also surface treated so that they are aligned in relation to the molecules of the liquid crystalline compound 134. In FIG. 7a the particles 112 are aligned with their long axes perpendicular to the long axes of the liquid crystal molecules 134 due to surface treatment with a surfactant. Thus, in the resting state (V=0) shown in FIG. 7a, the anisometric particles 112 assume a defined orientation with respect to the liquid crystal molecules 134.

Application of an electric field, of strength V as shown in FIG. 7b, causes the liquid crystal molecules with negative dielectric anisotropy 134 to realign in a direction perpendicular to the applied field. The anisometric particles 112, whose orientation is linked to the liquid crystal molecules 134, also realign to remain perpendicular to the liquid crystal molecules 134. Increasing the field further does not change the direction of orientation of the liquid crystal molecules or the anisometric particles.

When the electric field is turned off, both the liquid crystal molecules 134 and the anisometric particles 112 resume the orientations shown in FIG. 7a.

Thus, the embodiments shown in FIGS. 4 to 7 provide alignment of anisometric particles in two defined orientations, and rapid reversible switching between these orientations.

It will be clear to those skilled in the art that there are numerous embodiments within the scope of this invention, and that by altering the type of surface treatment of both the surface adjacent to the liquid crystal composite and the anisometric particles, it is possible to achieve different results. Further the type of liquid crystal chosen will influence the result achieved. For example, some embodiments will allow the transmission of light through the cell in the absence of a voltage, but block the transmission of light when an electric field is applied. Other embodiments will reflect light when no voltage is applied but allow the transmission of light when an electric field is applied.

The anisometric particles may comprise a single layer or several layers of material, which may be metallic, organic or inorganic. For example, the particles may comprise a layered dielectric material reflecting a certain band of light. They may alternatively consist of two different layers having different physical (e.g. optical) or chemical surface properties. For example, a rigid substrate layer may be combined with an optically reflective layer. Such a technique may be used to increase the rigidity of reflective particles. It is also possible to combine layers that react with different molecules in different ways. For example, one of the surfaces may be chosen so that it specifically reacts with a polar molecule while the other surface may have a high reactivity with an apolar substance. In this way, particles with specific polar and apolar surfaces can be produced. The orientation of such particles may be easily controlled.

Various methods of preparing the anisometric particles used in the invention will now be described. Those skilled in the art will be aware that certain methods are preferred when producing particles made of certain materials, since some methods result in particles having large variations in shape and size, whilst others result in particles having a specific size, shape and/or surface property. One method is based on the evaporation of a thin layer on top of a substrate having a release coating, followed by its release and milling to small particle sizes. Other methods include the use of naturally occurring minerals such as mica, which can also be milled. Silicon and aluminium particles may be produced in solution.

Anisometric particles may also be obtained by the growth of crystals, in particular needle-like crystals. Nano-rods of metals or other inorganic materials may also be obtained during their synthesis in solutions when suitable surfactants are used. Using this method, disc and flake-like anisometric particles may also be produced. Rod-like particles may be grown in templates, following which the template may be removed leaving behind the rod-like particles. Other anisometric particles may be grown from the vapour phase when suitable surfaces with nucleating sites are used.

FIG. 8 schematically shows a first method of producing anisometric particles for use in embodiments of the present invention. This method may be performed using a variety of techniques such as offset printing, micro contact printing and inkjet printing. In all of these techniques, except for inkjet printing, a patterned surface or a surface to which ink has been transferred in a patterned way (a stamp) is used to transfer ink 140 to another surface comprising a layer to be patterned 142. The ink may be used as a positive or negative etch resist, depending on the type in ink. If it is used as a negative etch resist, material of the layer to be patterned 142 can be removed selectively by etching from those areas that are not covered or modified by the ink 140. If the ink is used as a positive etch resist, a second layer of ink providing a higher etch resistance is applied only to the so far unmodified areas of the surface (e.g. by deposition via self-assembly from solution). In this case, in the subsequent etching step, material is removed from those areas that had been modified with the first ink (the one with the lower etch resistance). Other inking-etching schemes are also possible, including the local (patterned) chemical modification of the ink already deposited on the surface.

It is important that the layer to be patterned 142 has a release layer 144 underneath it (between the layer to be patterned 142 and a substrate 146). The release layer 144 can then be dissolved in a suitable solvent leaving the free patterned structures 148 (particles of various shapes and dimensions) dispersed in the solvent, as shown in FIG. 8. The ink 140 may or may not be removed by dissolution in this solvent. If desired, the ink 140 may also be removed in another subsequent processing step.

It is also possible to use inkjet printing to produce the desired patterns. In that case the ink 140 can be brought on top of the layer to be patterned 142 in the form of micro droplets. Further processing will be analogous to the above description. However, due to its sequential nature, the inkjet printing technique is generally slower.

Optical lithography may also be used to pattern a layer of photoresist material covering the layer to be patterned 142 using a photomask. After development of the resist layer, the layer to be patterned 142 may be etched and particles 148 of various shapes and dimensions are produced in the same way as described above.

FIG. 9 schematically shows a second method of producing anisometric particles for use in embodiments of the present invention. A mask 150 is used to deposit a layer of particles 152 onto a substrate 154 provided with a release layer 156. The release layer 156 is then dissolved, thus producing free particles 153 of various shapes and dimensions.

The mask 150 may also be manufactured on top of the substrate 154 as shown in FIG. 10. In this case, the particles 152 deposited on top of the mask 150 can be removed using a suitable solvent, thus providing free particles 153, while the material 158 deposited on an adhesion layer 160 is not removed. It is also possible to use an inverse technique where the deposited material adheres to the mask surfaces 150 and the material 158 deposited between the mask surfaces 150 is released.

Surface modification of the particles of various shapes and dimensions, is essential according to the present invention, and the nature of the surface modification is an important factor in determining the orientation of the particles within the liquid crystal composite.

Suitable surface treatments of the surfaces of the particles will be known to those skilled in the art, and include techniques such as uniaxial rubbing, photoalignment and treatment with surfactant. For example, gold particles may be treated with the cyano biphenyl thiol molecule (I) shown below:

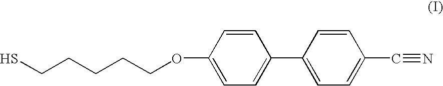

Particles treated with molecule (I) become orientated in the direction perpendicular to the liquid crystal molecules. The particles may alternatively be treated with the biphenyl thiol molecule (II) shown below:

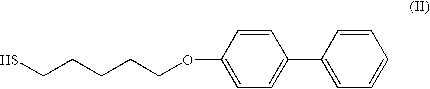

Particles treated with the molecule (II) become oriented in the direction parallel to the liquid crystal molecules.

The skilled person will recognize that many other known surface treatments may be applicable. The skilled person will also be aware that the above exemplary treatment may be suitable for the substrates of the liquid crystal cell.

In order to stabilize the particle suspension and avoid sedimentation or sticking of the particles to the cell surfaces, polymeric liquid crystals may also be included in the liquid crystal mixture. It may also be advantageous to cross-link such a polymer in-situ in order to get better stabilization.

By way of example, a number of alternative embodiments of the invention will now be described.

In a first example, gold flakes treated with the above cyano biphenyl thiol molecule (I) are placed in a cell containing liquid crystal molecules E7 (Merck, Darmstadt). E7 is a well-known liquid crystal mixture containing molecules with cyano biphenyl and cyano terphenyl groups. The surfaces of the cell were covered by polymer Sunever polyamide type 626 (Nissan chemicals, Japan) which is known to induce perpendicular alignment of liquid crystals with respect to the surfaces. Thus, liquid crystal molecules in the cell immediately become oriented perpendicular to the cell surfaces and the flakes immediately assume an orientation perpendicular to liquid crystal molecules, as shown in FIG. 5a. FIG. 11 shows a representation of the flakes, viewed from the top surface of the cell. Thus, it is apparent that the flakes are oriented parallel to the cell surface. This orientation of the flakes is associated with the interaction between the dipole of the molecules on the flake surfaces and the dipoles of the liquid crystal molecules.

In a second example, gold flakes are treated with the above biphenyl thiol molecule (II) and placed in a cell containing liquid crystal molecules Zli 2857 (Merck, Darmstadt) with a uniaxial orientation, as shown in FIG. 5a. Zli 2857 is a mixture having negative dielectric anisotropy and containing molecules with lateral dipoles such as the molecule (III) shown below:

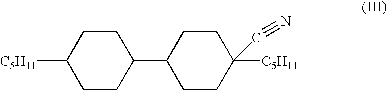

The surfaces of the cell are covered with polymer Sunever polyamide type 626 (Nissan chemicals, Japan), which is known to induce perpendicular alignment of liquid crystals with respect to the surfaces. Liquid crystal molecules in the cell therefore immediately become oriented perpendicular to the cell surfaces, and the particles immediately assume an orientation parallel to liquid crystal molecules and became oriented perpendicular to the cell surfaces. This shows the importance of the dipolar interactions in determining the orientation direction of the particles with respect to the liquid crystal molecules.

In a third example, gold flakes are treated with a cyano biphenyl thiol molecule, as in the first example. However, the treated flakes are placed in a cell containing E7 liquid crystal molecules aligned with their long axes parallel to the adjacent uniaxially rubbed poymer surface (JSR AL1051), as shown in FIG. 4a. The flakes immediately assume an orientation perpendicular to liquid crystal molecules, as expected. FIG. 12 is a representation of the flakes, viewed from the top surface of the cell. Thus, it is apparent that the flakes are oriented perpendicular to the cell surface.

Further evidence for the liquid crystal-induced orientation of the flakes may be observed during the heating of flakes above the clearing temperature of the liquid crystal material. This effect is shown in the representations of FIGS. 13a and 13b. In FIG. 13a, the liquid crystal molecules, at room temperature, are oriented perpendicular to the cell surfaces. Upon heating the liquid crystal above the clearing temperature the flakes assume an orientation parallel to the cell surfaces, as shown in FIG. 13b.

FIGS. 14 and 15 show the results of applying an electric pulse of 5 V across the cell of the first example described above. FIG. 14 shows that upon application of the voltage, the flakes rotate very fast and becomes aligned in the direction of the applied field. An increase in light transmission through the cell is observed. Upon removal of the voltage the flakes return very quickly to the initial state of orientation, where very little light is transmitted through the cell. FIG. 15 is a representation of the continuously changing orientation of a flake which occurrs when the voltage is applied.

It is to be understood that this detailed description discloses specific embodiments of a broader invention and is not intended to be limiting. There are many other embodiments within the scope of the invention as claimed hereafter, and these will be apparent to those skilled in the art.

1. A liquid crystal composite (110) comprising anisometric particles (112, 113) suspended in a liquid crystalline compound (114, 134) characterised in that the particles are aligned in relation to the molecules of the liquid crystalline compound, and the orientation of the particles may be reversibly changed by the application of an electric field.

2. A liquid crystal composite according to claim 1, wherein the surfaces of the particles are treated with surfactant.

3. A liquid crystal composite according to claim 2, wherein the surfactant comprises a compound containing one or more thiol groups.

4. A liquid crystal composite according to claim 2, wherein the surfactant comprises a compound containing one or more silane groups.

5. A liquid crystal composite according to claim 1, wherein the surfaces of the particles are treated by uniaxial rubbing.

6. A liquid crystal composite according to claim 1, wherein the surfaces of the particles are treated by photo-alignment.

7. A liquid crystal composite according to claim 1, wherein the thickness of the particles is in the range 5 nm to 1 μm, and the length of the particles is in the range 20 nm to 50 μm.

8. A liquid crystal composite according to claim 1, wherein the surfaces of the particles reflect visible light.

9. A liquid crystal composite according to claim 1, wherein the surfaces of the particles absorb visible light.

10. A liquid crystal composite according to claim 1, wherein the ratio between thickness and length of the particles is at least 1:5.

11. A liquid crystal composite according to claim 1, wherein the particles are 10% by weight or less of the composite.

12. A liquid crystal composite according to claim 1, wherein the particles are metallic particles.

13. A liquid crystal composite according to claim 1, wherein the length of the particles is less than 1 μm, the particles having been synthesised from a solution.

14. A liquid crystal cell (100, 120, 130, 170) comprising:
first and second substrates (102, 104) spaced apart, at least one substrate being transparent;
first and second electrodes (106, 108) formed on the respective first and second substrates, at least one electrode being transparent;
first and second alignment layers (116, 118, 122, 132, 176, 178) formed on the respective first and second electrodes; and
the liquid crystal composite (110) according to claim 1 disposed between the two substrates.

15. A method of reversibly changing the orientation of anisometric particles (112, 113) in a liquid crystal composite (110), the method comprising the steps of:
suspending the particles in a liquid crystalline compound wherein the particles are aligned in relation to the molecules of the liquid crystalline compound; and
applying an electric field across the composite.

16. The method of claim 15, further comprising an initial step of treating the surfaces of the particles.

17. The method of claim 15, further comprising the step of bringing the suspension between two parallel substrates (102, 104) prior to the step of applying the electric field.

18. A display device comprising the liquid crystal cell (100, 120, 130, 170) according to claim 14.

19. A switchable mirror comprising the liquid crystal cell (100, 120, 130, 170) according to claim 14.

20. Means for changing the direction or shape of a beam of light from a light source comprising the liquid crystal cell (100, 120, 130, 170) according to claim 14.
